(19) United States
(12) Patent Application Publication
(10) Pub. No.: US 2008/0205609 A1
(43) Pub. Date: Aug. 28, 2008

(54) METHOD, SYSTEM AND APPARATUS FOR ADJUSTING THE TRANSMIT POWER OF THE DSL TRANSCEIVER

(75) Inventor: Jun ZHOU, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/117,319

(22) Filed: May 8, 2008

Related U.S. Application Data
(63) Continuation of application No. PCT/CN2006/002331, filed on Sep. 11, 2006.

(30) Foreign Application Priority Data
Nov. 8, 2005 (CN) 200510117662.8

(51) Int. Cl. H04M 11/00

(52) U.S. Cl. 379/93.08

(57) ABSTRACT

A method, system and transceiver for adjusting the transmit power seamlessly, which comprises: acquires the noise margin of the received signal, and compares the acquired noise margin with the threshold of the noise margin; when the noise margin of the signal has continually exceeds the threshold of the noise margin for a predetermined period, the noise margin is adjusted to the target range of the noise margin by adjusting the signal transmit power. Therefore, the technique scheme could adjust the transmit power of the transceiver with the varying of noise margin, which ensures the stability and the low error rate of the data transmission and reduces the crosstalk of the line by minimizing the transmit power of the transceiver.

### CROSS-REFERENCE TO RELATED APPLICATIONS

This application is a continuation of International Application No. PCT/CN2006/002331, filed Sep. 11, 2006, which claims priority to Chinese Patent Application No. 200510117662.8, filed Nov. 8, 2005, both of which are hereby incorporated by reference in their entirety.

### FIELD OF THE INVENTION

The present invention relates to the field of communication technologies and in particular to a method, system and apparatus for adjusting transmit power of a digital subscriber line transceiver.

### BACKGROUND OF THE INVENTION

In a communication system, the Digital Subscriber Line (xDSL) access is an access technology widely applied at present. The xDSL access is a high speed data access technology for transmission over an Unshielded Twisted Pair (UTP). The xDSL access involves various specific technical solutions. In addition to Digital Subscriber Lines (DSL) for baseband transmission such as the Internet Digital Subscriber Line (IDSL) and the Single pair High bit rate Digital Subscriber Line (SHDSL), the band-pass transmitted xDSL takes advantages of the frequency division multiplexing technology, so that the xDSL and the Plain Old Telephone Service (POTS) coexist over the same twisted pair. The xDSL service occupies the high frequency band, the POTS occupies the baseband part below 4 KHz, and POTS and xDSL signals are separated by a splitter. The band-pass transmitted xDSL adopts the Discrete Multi-Tone (DMT) modulation. A system enabling a multi-access of xDSL is referred to as a DSL access multiplexer (DSLAM), a systematic reference model of which is as illustrated in FIG. 1.

Since the xDSL is transmitted over the UTP originally designed for transmission of voice signals, the UTP presents numerous impairment factors to high frequency signals, such as external interference, noise and ambient variations, causing change of a line parameter, and thereby resulting in instability of xDSL operation. Many means, such interleaving and error correction coding, have been adopted in the xDSL technologies to deal with these impairments. Additionally, some dynamic features such as Seamless Rate Adaptation (SRA) have been defined for adapting to change of the channel conditions such as external interference, noise and temperature.

The Seamless Rate Adaptation is implemented as follows. When a line condition degrades and a noise margin of the xDSL link falls below a first predetermined value, the SRA can decrease a line rate automatically to ensure that a bit error ratio and the noise margin can satisfy a communication requirement. When the line condition becomes improved and the noise margin rises beyond a second predetermined value, the SRA can increase the line rate automatically so that the noise margin can be kept within a preset range. The entire adaptation process requires no disconnection for retraining.

However, the seamless rate adaptation also has drawbacks. In a practical application, many operators adopt a fixed-rate operation mode, not permitting to change the line rate. Thus, the SRA does not function. Furthermore, even in the case that the SRA is enabled when the operators restrict the rate range, the noise margin might still exceed the preset threshold when the channel condition improves and the SRA adapts the line rate to the upper limit of the restricted rate range. At this time, the exceeding noise margin results from transmission by a transceiver of power more than required, which may introduce unnecessary crosstalk as well as power consumption.

There is currently another method for dealing with the instability above by defining Power Cut Back (PCB), a target noise margin, a maximum noise margin, a minimum noise margin, power management, etc.

In this method, the PCB can reduce the transmit power in case of a short line. When an actual noise margin is greater than the preset maximum noise margin, a modem may reduce the noise margin subject to the restriction of the maximum noise margin by reducing the transmit power. For example, the ADSL2 may cut the transmit power by up to 40 dB, so as to make the noise margin satisfy the restriction of the maximum noise margin, thereby reducing effectively the transmit power in case of restricted- or fixed-rate activation.

However, the PCB method above functions only during training. During showtime of normal operation, transmit power of the transceiver will not be changed. Thus, during showtime of normal operation, the noise margin may still exceed the maximum noise margin due to improvement of the channel (such as noise decreasing). At this time, the transceiver may transmit power more than required, thereby resulting in unnecessary crosstalk and power consumption.

Another existing method is a power management method which introduces an L2 power management mode as defined in the ADSL2. When activating a modem (an L0 mode), the modem may enter the L2 mode with lower power consumption automatically if the user data rate falls below a preset threshold for a period of time exceeding a preset threshold due to some reason (e.g., the subscriber is temporarily absent from his computer). At this time, the line is kept for connection at a lower rate. The system can enter the L0 mode automatically if the data rate of the subscriber rises.

However, this power management method is primarily focused on whether the subscriber is actually online and adjusts transmit power of the transceiver based upon the data traffic of the subscriber. The transceiver may still transmit excessive power even in the L0 mode, thereby resulting in unnecessary crosstalk.

### SUMMARY OF THE INVENTION

In view of above, according to embodiments of the invention, there is provided a method, system and apparatus for adjusting transmit power of a digital subscriber line transceiver, which can minimize transmit power of the transceiver and further reduce line crosstalk and apparatus power consumption while satisfying a rate and a noise margin required for a subscriber.

The object of the invention can be achieved by the following technical solutions.

A method for adjusting transmit power of a digital subscriber line transceiver includes:

obtaining and comparing a noise margin at a receiver with a preset noise margin threshold; and

adjusting transmit power when the noise margin exceeds the preset noise margin threshold for a predetermined time interval.

The following technical solutions of the method are optional.

The process of adjusting transmit power includes:

enabling a timer to start timing when the noise margin goes beyond the preset noise margin threshold; and

clearing the timer when the noise margin comes back into the noise margin threshold.

The method further includes:

configuring an upshift noise margin, a downshift noise margin, a target noise margin, an upshift time interval and a downshift time interval prior to transceivers' initialization.

The process of adjusting transmit power includes:

enabling a timer to start timing at the receiver when its noise margin rises above an upshift noise margin;

clearing the timer and generating a trigger signal if the noise margin stays above the upshift noise margin when the timer reaches an upshift timer interval;

calculating and sending, by the receiver, a power adjustment amount to the sender upon receiving the trigger signal; and

decreasing, by the sender, the transmit power according to the power adjustment amount.

The method for calculating the power adjustment amount by the receiver includes calculating a gain scaling table or both the gain scaling table and bit allocation table.

The method for calculating the gain scaling table includes:

flat adjustment to all sub-carriers to increase or decrease by the same amount; or

weighted adjustment in which different sub-carriers are adjusted with different amplitudes according to a preset weighting rule.

The flat adjustment is:

the adjustment amount in decibels equal to the noise margin minus a target noise margin.

The process of adjusting transmit power includes:

if the timer does not exceed an upshift time interval, no trigger signal is generated and no power adjustment is calculated and sent.

The process of adjusting transmit power includes:

enabling a timer to start timing when the noise margin falls below a downshift noise margin;

sending a trigger signal and clearing the timer if the noise margin stays below the downshift noise margin when the timer reaches a downshift timer interval;

calculating and sending, by the receiver, a power adjustment amount to the sender upon receiving the trigger signal; and

increasing, by the sender, the transmitting power according to the power adjustment amount.

The process of adjusting transmit power includes:

if the timer value does not exceed the downshift time interval, no trigger signal is generated and no power adjustment amount is calculated and sent.

When signal transmit power is required to be upshifted, if the adjusted signal transmit power spectrum density (PSD) exceeds a PSD mask or the transmit power exceeds the aggregate transmit power restriction, signal transmit power is adjusted to the PSD mask or the aggregate transmit power restriction or a retraining is initiated.

The method according to embodiments of the invention is based upon discrete multi-tone modulation, and is applicable in the field of the second generation asymmetric digital subscriber line (ADSL2) or the second generation asymmetric digital subscriber line with an extended downlink bandwidth (ADSL2+), and is also applicable in the fields of the very high speed digital subscriber line (VDSL) and the second generation very high speed digital subscriber line (VDSL2).

According to embodiments of the invention, there is further provided a system for adjusting transmit power of a digital subscriber line transceiver including:

a signal sending means and a signal receiving means adapted to send a signal to a line and to receive a signal from the line;

a noise margin obtaining means adapted to obtain information on a noise margin of the signal received by the receiving means;

a comparator adapted to compare the noise margin obtained by the noise margin obtaining means with a noise margin threshold stored in a parameter configuration module;

a timer adapted to time the consecutive duration of noise margin staying beyond the predefined range and trigger an adjusting means when timer reaches predefined time threshold;

the adjusting means adapted to calculate and send an adjustment amount to a sender to enable the sender to adjust transmit power according to the adjustment amount; and

an executing means adapted to adjust signal transmit power according to the adjustment amount received by the sender.

The following technical solutions of the system are optional.

The system further includes:

the parameter configuration module adapted to receive and store an upshift noise margin, a downshift noise margin, a target noise margin, an upshift time interval and a downshift time interval.

The executing means is arranged in apparatus of the sender; and

the noise margin obtaining means, the comparator, the timer and the adjusting means are arranged in apparatus of a receiver.

Both the apparatus of the receiver and the apparatus of the sender include the signal receiving means, the signal sending means and the parameter configuration module.

According to embodiments of the invention, there is further provided a method for adjusting transmit power of a digital subscriber line transceiver, including:

obtaining and comparing a signal-to-noise ratio of a received signal with a preset signal-to-noise ratio threshold; and

adjusting signal transmit power to adjust the signal-to-noise of the received signal into the preset signal-to-noise range when a period of time for which the signal-to-noise of the received signal stays beyond the signal-to-noise threshold reaches a predetermined value.

According to embodiments of the invention, there is further provided a transceiver including:

a noise margin obtaining means adapted to obtain a noise margin of a signal received by a receiving means;

a comparator adapted to compare the obtained noise margin with a preconfigured noise margin threshold stored in a parameter configuration module;

a timer adapted to trigger an adjusting means when determining that a period of time for which the noise margin of the received signal stays beyond the noise margin threshold reaches a predetermined value;

the adjusting means adapted to calculate and send an adjustment amount to an opposite transceiver to enable the opposite transceiver to adjust transmit power according to the adjustment amount; and

an executing means adapted to execute adjustment of signal transmit power according to the adjustment amount sent from the opposite transceiver.

As can be seen from the technical solutions above according to embodiments of the invention, transmit power of the transceiver is enabled to be adjusted as the noise margin varies, ensuring stability and a low bit error rate of data transmission, while minimizing transmit power of the transceiver and reducing line crosstalk.

### BRIEF DESCRIPTION OF THE DRAWINGS

FIG. 1 illustrates a reference model of a Digital Subscriber Line xDSL system;

FIG. 2 illustrates a block diagram of logic functions in seamless rate adaptation;

FIG. 3 illustrates a schematic diagram of noise adjustment in seamless rate adaptation; and

FIG. 4 illustrates an operational flow diagram of seamless rate adaptation.

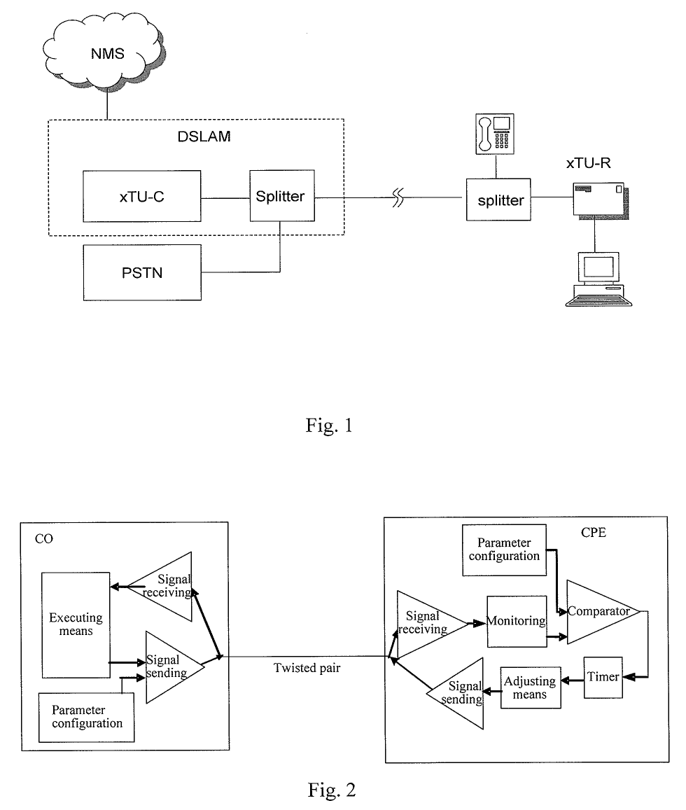

### DETAILED DESCRIPTION OF THE INVENTION

According to embodiments of the invention, a noise margin of a received signal is obtained, and the noise margin of the received signal is adjusted by adjusting transmit power of the signal, so as to minimize transmit power of a transceiver and further reduce crosstalk and apparatus power consumption by adjusting transmit power of the transceiver in response to change of a line condition (such as insertion loss and background noise) while satisfying a rate and a noise margin required for a subscriber. Further, unnecessary adjustment of transmit power due to rapidly changing noise or the like can be avoided.

A technical solution of adjusting transmit power of a transceiver according to embodiments of the invention can be referred to as a Seamless dynamic Transmit power Adjustment (STPA) technology. The clew of the STPA lies in that a noise margin is kept within a certain range by adjusting transmit power when a line condition changes.

The method and system according to embodiments of the invention will be further described in details below with reference to the drawings.

The following parameters are introduced in the invention.

Target noise margin (TMGN) of a line;

Upshift noise margin (UMGN);

Downshift noise margin (DMGN);

Upshift time interval (USHTI); and

Downshift time interval (DSHTI).

The method and system according to embodiments of the invention will be described below with reference to FIG. 2, taking it as an example that the STPA is implemented for a downlink signal between a Central Office (CO) and a Customer Premise Equipment (CPE). In FIG. 2, the system for adjusting transmit power of a digital subscriber line transceiver is divided into two major parts: a Central Office (CO) and a Customer Premise Equipment (CPE).

The CO includes a signal receiving means, a signal sending means, an executing means and a parameter configuration means.

The signal receiving means is adapted to receive a signal from a line and the signal sending means is adapted to send a signal to the line.

The parameter configuration means is adapted to receive and store an upper limit of a noise margin threshold, i.e. an upshift noise margin, and a lower limit of the noise margin threshold, i.e. a downshift noise margin, a target noise margin, an upshift time interval as the time threshold of the noise margin exceeds the upshift noise margin, and a downshift time interval as the time threshold of the noise margin exceeds the downshift noise margin, which are configured in advance.

The executing means is adapted to execute power adjustment when receiving a transmit power adjustment amount sent from the CPE.

The CPE includes a signal receiving means, a signal sending means, a noise margin obtaining means, a parameter configuration means, a comparator, a timer and an adjusting means.

Operations executed by the signal receiving means and the signal sending means in the CPE are identical to those of the signal receiving means and the signal sending means in the CO, i.e. receiving a signal from the line and sending a signal to the line.

The parameter configuration means of the CPE is adapted to receive from CO and store the upshift noise margin, the downshift noise margin, the target noise margin, the upshift time interval and the downshift time interval, which are configured in advance.

The noise margin obtaining means is adapted to obtain and output a noise margin of the signal received by the signal receiving means. The noise margin obtaining means can obtain the noise margin of the received signal by real time monitoring, periodically monitoring, etc.

The comparator is adapted to compare the obtained noise margin from the noise margin obtaining means with the preconfigured upshift noise margin and the downshift noise margin stored in the parameter configuration module of the CPE and to trigger the timer to start timing when the obtained noise margin from the noise margin obtaining means exceeds the range delimited by the upshift noise margin and the downshift noise margin. The comparator is also adapted to stop the timer from timing and clear the timer when the obtained noise margin from the noise margin obtaining means falls back to the range delimited by the upshift noise margin and the downshift noise margin.

The timer is adapted to start timing in response to the trigger from the comparator and to trigger the adjusting means when a timing value reaches a predetermined value.

The adjusting means is adapted to calculate an adjustment amount of transmit power for the transceiver at the CO in response to the trigger from the timer and to send the adjustment amount to the central office so that the central office can adjust transmit power of the transceiver according to the adjustment amount.

An operational flow of the system for adjusting transmit power of a digital subscriber line transceiver according to embodiments of the invention is described as follows.

Prior to initialization of the CO and the CPE, parameters including a target noise margin (TMGN), an upshift noise margin (UMGN), a downshift noise margin (DMGN), an upshift time interval (USHTI) and a downshift time interval (DSHTI) are set in compliance with a relationship of UMGN>TMGN>DMGN.

The system will initialize and enter showtime mode subject to the preset parameters. The noise margin obtaining means of the CPE monitors a noise margin (NMGN) of a signal received by the CPE, and the comparator compares the NMGN with the upshift noise margin and the downshift noise margin stored in the configuration parameter module. If the NMGN goes beyond the range delimited by the UMGN and the DMGN, the comparator triggers the timer to start timing. The timer is cleared if the NMGN comes back within the range delimited by the UMGN and the DMGN during timing of the timer.

When the timing of the timer goes beyond the downshift time interval (DSHTI) stored in the configuration parameter module, the adjusting means calculates a new bit allocation and gain (Bi&Gi) from current Bi&Gi tables, the current NMGN, and the preset UMGN and DMGN, and sends new Bi&Gi to the CO through the signal sending means. The adjusting means can also calculate a Power Cut Back (PCB) value, which is uniform for each tone or sub-carrier, and sends the PCB to the CO through the signal sending means.

After the CO receives the new Bi&Gi through the signal receiving means, the executing means adjusts transmit power according to the Bi&Gi adjustment signal. The executing means sends trigger signal to indicate the switching to the new Bi&Gi. After receiving the showtime indication signal, the CPE will execute demodulation using the new Bi&Gi upon the indication of trigger signal. The trigger information can be synch symbol in ADSL2/2+, for example.

After the CO receives new PCB through the signal receiving means, the executing means adjusts a power spectrum density of a signal transmitted from the transceiver. The executing means sends a trigger signal as a synchronous signal to indicate the CPE the new power spectrum density will come into effect. The receiver CPE will execute demodulation using the new PSD upon the receiving of the indication of trigger signal. The trigger information can be synch symbol in ADSL2/2+, for example.

According to embodiments of the invention, the STPA can also be implemented for an uplink signal between the Central Office (CO) and the Customer Premise Equipment (CPE). The implementation of STPA for an uplink signal is analogous to that for a downlink signal, and will no more be described here.

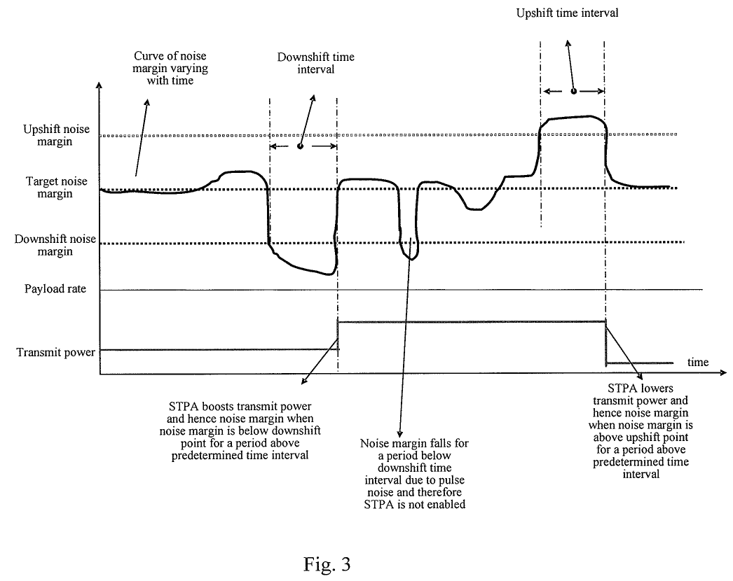

As can be seen from FIG. 3, when a channel feature, such as ambient temperature and humidity, or noise changes, the noise margin also varies with time. The system adjusts signal transmit power of the transceiver according to a range over which the noise margin varies. When the noise margin falls below the downshift noise margin, the timer starts timing. If this situation lasts beyond the downshift time interval, the adjusting means increases transmit power, i.e. Gi, and sends a new Bi&Gi table to the sender such as the CO. Both the sender and the receiver are switched to the new Bi&Gi table concurrently after a predetermined period of time elapses.

When the channel feature becomes improved so that the noise margin rises above the upshift noise margin, the timer starts timing. If the timing value of the timer goes beyond the upshift timer interval while the noise margin is kept beyond the upshift noise margin, the adjusting means lowers transmit power, i.e. Gi, and sends a new Bi&Gi table to the sender. Both the sender and receiver are switched to the new Bi&Gi table after a predetermined period of time elapses.

If the noise margin falls due to pulse noise or the like, the timer is reset and it does not send out any trigger signal and the STPA does not function because the pulse noise lasts transitorily.

As described above with reference to FIG. 3, the sender adjusts signal transmit power by adjusting the Bi&Gi table. Alternatively, the sender can adjust signal transmit power through PCB.

It is not necessary to interrupt any ADSL service throughout the implementation of the invention. Therefore, ADSL service of the customer can be considered seamless.

In a technical solution according to embodiments of the invention, a channel for transmission of a message can be a channel for transmission of an Embedded Operation Channel (EOC) message of the ADSL2. Signal transmit power can be adjusted by adjusting Gi only or both Bi and Gi. If Gi is adjusted only, the receiver may send only new Gi to the sender. Thus, the message transmission time can be saved, and a responding speed of the sender adjusting signal transmit power can be accelerated, thereby improving robustness of the system.

There are two main Gi adjustment schemes. One scheme is flat adjustment, i.e. power of all the sub-carriers is increased or lowered concurrently by the same amount, and this adjustment scheme is simple to be implemented. The other scheme adopts a preset weighting rule that different adjustment amplitudes are applied to different sub-carriers, and this adjustment scheme may possibly change a Bi table.

For the flat adjustment, the adjustment amplitude of signal transmit power can be calculated from the following equation:

20 logGi′=20 logGi−(NMGN−TMGN).

The solutions of adjusting signal transmit power according to embodiments of the invention can also be applied in combination with another Power Spectrum Density (PSD) mask. For example, when signal transmit power is required to be upshifted, if the adjusted power exceeds upper limit of the PSD mask or an overall power restriction, the PSD mask and the overall power restriction can be used as an upper limit of adjusting signal transmit power. Alternatively, transmit power can be adjusted with retraining if the adjusted power exceeds the PSD mask or the overall power restriction. In a practical application, whether the PSD mask and the overall power restriction are used as an upper limit of adjusting signal transmit power or the transmit power is adjusted with retraining can be decided dependent upon a practical demand of an operator.

The invention is based upon Discrete Multi-Tone (DMT) modulation, is applicable in the field of the second generation asymmetric digital subscriber line or the second generation asymmetric digital subscriber line with an extended downlink bandwidth, and also is applicable in the fields of the very high speed digital subscriber line and the second generation very high speed digital subscriber line.

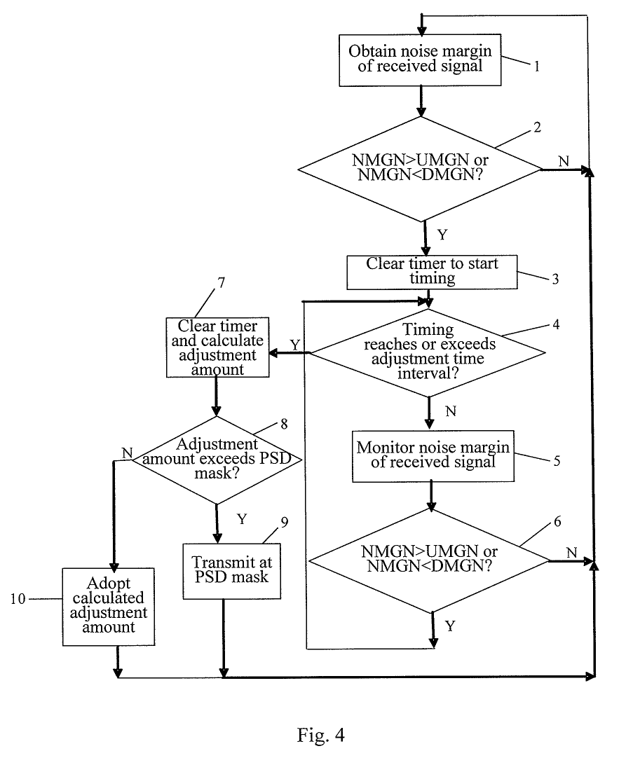

A specific STPA flow according to embodiments of the invention will be described below with reference to FIG. 4.

Block 1: The noise margin obtaining means monitors a noise margin of a received signal.

Block 2: The comparator compares a monitoring result with the upshift noise margin (UMGN) and the downshift noise margin (DMGN) configured in advance in the parameter configuration module to determine whether the condition of NMGN>UMGN or NMGN<DMGN holds true, and executes the following operations according to a determination result.

If the condition holds true, it indicates that the noise margin goes beyond the allowable range, and at this time, the flow goes to the Block 3 where the comparator triggers the timer and the timer is cleared and starts timing.

If the condition does not hold true, it indicates that the noise margin is within the allowable range, and at this time, the comparator does not trigger the timer and the flow goes to the Block 1, continuing with obtaining a noise margin and with subsequent comparison.

Block 3: After the timer is triggered, the timer is cleared and starts timing. The timing value of the timer indicates a period of time for which the noise margin of the signal stays beyond the allowable noise margin range.

Block 4: It is determined whether the timing value of the timer reaches or exceeds either of the adjustment time intervals preset in the parameter configuration module. If the timing value reaches or exceeds either of the adjustment time intervals, the flow goes to the step 7. Otherwise, the flow goes to Block 5, continuing with monitoring a noise margin of a received signal.

Change of the noise margin due to pulse noise is transitory, and the noise margin can come back within the allowable range quickly. Therefore, it is not necessary to adjust signal transmit power if the period of time for which the noise margin stays beyond the allowable noise margin range is transitory. Thus, at Block 5, if the noise margin goes beyond the allowable noise margin range for a period of time which does not reach either of the preset time intervals, the flow continues with monitoring a noise margin of a received signal, and then goes to Block 6.

Block 6: The comparator compares a monitoring result with the upshift noise margin and the downshift noise margin configured in advance in the parameter configuration module to determine whether the condition of NMGN>UMGN or NMGN<DMGN holds true.

If the condition holds true, it indicates that the noise margin stays beyond the allowable range. The timer continues with timing, and the flow goes to Block 4, continuing with determining whether the timing value of the timer reaches or exceeds either of the adjustment time intervals preset in the parameter configuration module.

If the condition does not hold true, it indicates that the noise margin is within the allowable range. The flow goes back to Block 1, obtaining a noise margin and continuing with subsequent comparison.

The descriptions above have been made to the flow in the case that the timing value of the timer does not reach either of the adjustment time intervals preset in the parameter configuration module in Block 4. Descriptions will be made below to the flow in the case that the timing value of the timer reaches either of the adjustment time intervals preset in the parameter configuration module.

If the timing value of the timer reaches either of the adjustment time intervals preset in the parameter configuration module, the flow goes to Blocks 7 to 10.

Block 7: When the timing of the timer reaches or exceeds either of the time intervals, the timer is cleared while starting the adjusting means to calculate an adjustment amount of signal transmit power.

Block 8: It is determined whether the adjustment amount calculated at Block 7 exceeds the PSD mask. If the adjustment amount exceeds the PSD mask, the flow goes to Block 9. Otherwise, the flow goes to Block 10.

Block 9: The receiver sends the PSD mask to the sender. Thus, the sender adjusts signal transmit power according to the PSD mask. The present process of adjusting signal transmit power is ended, and the flow goes back to Block 1, continuing with monitoring a noise margin of a received signal.

At Block 8, the adjustment amount is compared with the PSD mask because the PSD mask is an upper limit determined for adjusting signal transmit power. Transmit power will be adjusted if this upper limit is exceeded.

Block 10: The receiver sends the calculated adjustment amount to the sender. Thus, the sender adjusts signal transmit power according to the calculated adjustment amount. The present process of adjusting signal transmit power is ended, and the flow goes back to Block 1, continuing with monitoring a noise margin of a received signal.

The flows above show a complete STPA operational flow.

Since there is a simple calculation relationship between a signal-to-noise ratio and a noise margin, the technical solutions above according to embodiments of the invention can also be modified to adjust transmit power based upon a signal-to-noise ratio. When transmit power is adjusted based upon a signal-to-noise ratio, the basic implementation principle is substantially the same as that for adjusting transmit power based upon a noise margin except that the threshold of the noise margin is modified to be that of the signal-to-noise ratio. In other words, when a period of time for which the signal-to-noise ratio of a received signal stays beyond the threshold of the signal-to-noise ratio, signal transmit power is adjusted so that the signal-to-noise ratio of the received signal is adjusted into the preset signal-to-noise ratio range, which will no more be described here.

The transceiver according to embodiments of the invention includes a noise margin obtaining means, a comparator, a timer, an adjusting means and an executing means. Operations executed by the respective elements in the transceiver are as described in the embodiments above.

The foregoing descriptions are merely illustrative of the preferred embodiments of the invention, and the scope of the invention shall not be limited to those descriptions. Any variations or alternatives which will readily occur to those skilled in the art shall come into the scope of the invention as defined in the appended claims.

What is claimed is:

1. A method for adjusting transmit power of a digital subscriber line transceiver, comprising:
obtaining and comparing a noise margin at a receiver with a preset noise margin threshold; and
adjusting transmit power when the noise margin exceeds the preset noise margin threshold for a predetermined time interval.

2. The method according to claim 1, wherein the process of adjusting transmit power comprises:
enabling a timer to start timing when the noise margin goes beyond the preset noise margin threshold; and
clearing the timer when the noise margin comes back into the noise margin threshold.

3. The method according to claim 1, further comprising:
configuring an upshift noise margin, a downshift noise margin, a target noise margin, an upshift time interval and a downshift time interval prior to transceivers' initialization.

4. The method according to claim 1, wherein the process of adjusting transmit power comprises:
enabling a timer to start timing at the receiver when its noise margin rises above an upshift noise margin;
generating a trigger signal and clearing the timer if the noise margin stays above the upshift noise margin when the timer reaches an upshift timer interval;
calculating and sending, by the receiver, a power adjustment amount to the sender upon receiving the trigger signal; and
decreasing, by the sender, the transmit power according to the power adjustment amount.

5. The method according to claim 4, wherein calculating the power adjustment amount by the receiver comprises calculating a gain scaling table or both the gain scaling table and bit allocation table.

6. The method according to claim 5, wherein calculating the gain scaling table comprises:
flat adjustment to all sub-carriers to increase or decrease by the same amount; or
weighted adjustment in which different sub-carriers are adjusted with different amplitudes according to a preset weighting rule.

7. The method according to claim 6, wherein the flat adjustment is:
the adjustment amount in decibels equal to the noise margin minus a target noise margin.

8. The method according to claim 1, wherein the process of adjusting transmit power comprises:
enabling a timer to start timing when the noise margin falls below a downshift noise margin;
sending a trigger signal and clearing the timer if the noise margin stays below the downshift noise margin when the timer reaches a downshift timer interval;
calculating and sending, by the receiver, a power adjustment amount to the sender upon receiving the trigger signal; and
increasing, by the sender, the transmitting power according to the power adjustment amount.

9. The method according to claim 1, wherein when signal transmit power is upshifted to exceed a power spectrum density mask or an overall power restriction, the sender sends the upper limit of transmitting signal.

10. The method according to claim 1, wherein the method is based upon discrete multi-tone modulation.

11. A system for adjusting transmit power of a digital subscriber line transceiver, comprising:
a signal sending means and a signal receiving means adapted to send a signal to a line and to receive a signal from the line;
a noise margin obtaining means adapted to obtain information on a noise margin of the signal received by the receiving means;
a comparator adapted to compare the noise margin obtained by the noise margin obtaining means with a noise margin threshold stored in a parameter configuration module;
a timer adapted to time the consecutive duration of noise margin staying beyond the predefined range and trigger an adjusting means when timer reaches predefined time threshold;
the adjusting means adapted to calculate and send an adjustment amount to a sender to enable the sender to adjust transmit power according to the adjustment amount; and
an executing means adapted to adjust signal transmit power according to the adjustment amount received by the sender.

12. The system according to claim 11, further comprising:
the parameter configuration module adapted to receive and store an upshift noise margin, a downshift noise margin, a target noise margin, an upshift time interval and a downshift time interval.

13. The system according to claim 11, wherein:
the executing means is arranged in apparatus of the sender; and
the noise margin obtaining means, the comparator, the timer and the adjusting means are arranged in apparatus of a receiver.

14. The system according to claim 11, wherein both the apparatus of the sender and the apparatus of the receiver comprise the signal receiving means, the signal sending means and the parameter configuration module.

15. A method for adjusting transmit power of a digital subscriber line transceiver, comprising:
obtaining and comparing a signal-to-noise ratio of a received signal with a preset signal-to-noise ratio threshold; and
adjusting transmit power when the signal to noise ratio exceeds the preset threshold for a predetermined time interval.

16. A transceiver, comprising:
a noise margin obtaining means adapted to obtain a noise margin of a signal received by a receiving means;
a comparator adapted to compare the obtained noise margin with a preconfigured noise margin threshold stored in a parameter configuration module;
a timer adapted to time the consecutive duration of noise margin staying beyond the predefined range and trigger an adjusting means when timer reaches predefined time threshold;
the adjusting means adapted to calculate and send an adjustment amount to an opposite transceiver to enable the opposite transceiver to adjust transmit power according to the adjustment amount; and
an executing means adapted to adjust signal transmit power according to the adjustment amount sent from the opposite transceiver.
